(19) United States
(12) Patent Application Publication
(10) Pub. No.: US 2026/0246222 A1
(43) Pub. Date: Aug. 20, 2026

(54) METHOD AND APPARATUS FOR CONTROLLABLY DE-ENERGIZING AMPLIFIER IN HIGH POWER NARROW LINEWIDTH FIBER LASER SYSTEMS

(71) Applicant: IPG PHOTONICS CORPORATION, Marlborough, MA (US)

(72) Inventors: Nikolai PLATONOV, Marlborough, MA (US); Roman YAGODKIN, Marlborough, MA (US); Joel DE LA CRUZ, Marlborough, MA (US); Valentin GAPONTSEV, Marlborough, MA (US)

(73) Assignee: IPG PHOTONICS CORPORATION, Marlborough, MA (US)

(21) Appl. No.: 19/489,555

(22) PCT Filed: Jan. 22, 2024
(86) PCT No.: PCT/US2024/012338

§ 371 Date: Dec. 2, 2025

Related U.S. Application Data
(60) Provisional application No. 63/470,566, filed on Jun. 2, 2023.

(51) Int. Cl. H01S 3/067; H01S 3/094; H01S 3/0941; H01S 3/10; H01S 3/106; H01S 3/30

(52) U.S. Cl. CPC H01S 3/06754; H01S 3/094003; H01S 3/09415; H01S 3/10015; H01S 3/1068; H01S 3/302; H01S 2301/03

(57) ABSTRACT

A high power narrow linewidth laser system is provided with a master oscillator power fiber amplifier (MOPFA) architecture which includes a master oscillator (MO) and booster. The laser system includes at least one photodetector (PD) operative to detect pulsed stimulated Brillouin scattered (SBS) light propagating backwards from the PA to the MO. The PD converts the detected SBS light to an electrical signal which corresponds to a pulse peak power of the detected SBS light. The laser system has a central processing unit (CPU) receiving the electrical signal and operable to determine if the peak power of the detected SBS light is within a threshold safety power range of the SBS light which ranges between 8 and 12 kW. If the peak power is within the threshold safety range, the CPU controllably decreases an output power of MO-generated signal light within a 50-500 ns time period prior to the shutdown of the booster so as to prevent the determined SBS peak power from reaching a critical peak power in a 1-5 MW.

### FIELD IF THE DISCLOSURE

This disclosure relates to high power laser systems having a master oscillator power fiber amplifier (MOPFA) architecture which includes a master oscillator and a power fiber amplifier. In particular, the disclosure relates to a safety system controlling the output of the maser oscillator prior to shutting down a pump, which energizes the fiber power amplifier so as to minimize detrimental effects of simulated Brillouin scattering (SBS) on laser system components.

### PRIOR ART

Over the years a series of advances in solid state laser sources, such as photonic rod, slab, thin-disc and fiber designs, have facilitated a significant advancement of laser technology leading to an exponential increase in the reported output powers of continuous wave (CW), quasi-CW (QCW) and pulsed laser sources which are configured with all or some fiber components. So much so that even a single narrow linewidth single transverse mode (SM) CW fiber laser source, i.e., the laser with the full width at half-maximum (FWHM) of its optical spectrum smaller than 1 nanometer (nm), can output substantially diffraction limited kW-level light. For example, a narrow linewidth 6.12 kW CW was reported by Wang et al. High Power Laser Science and Engineering, 10, E22., 2022.12.

High power narrow linewidth laser sources including single-frequency (SF) sources have been attracting extensive interest due to the superior performance on narrow spectral linewidth in kilohertz level and low noise for the applications ranging from coherent LIDAR, gravitational wave detection to spectral and coherent beam combination (SBC and CBC respectively.) To date, the known architectures of the narrow linewidth laser include short cavity with Fabry-Perot etalon, unidirectional ring cavity, and twisted mode cavity.

For higher laser power achievement, narrow linewidth laser sources outputting diffraction limited light typically have a MOPA architecture. While the reference to high power laser sources has no definitive numeric characteristics, within the scope of this disclosure any CW narrow linewidth fiber laser source outputting light between about a 500 W and about 5 kW power range is considered a high power laser source, whereas the 5 kW upper power limit may be somewhat higher in case of photonic rods, slabs and discs. Referring specifically to SF fiber laser systems, perhaps the maximum diffraction-limited output of these lasers is about 1 kW, but the latter possibly can be pushed somewhat higher. The MOPA architecture is used in CW, QCW and pulsed regimes and can be configured with all bulk laser components, all fiber laser components and a combination of bulk and fiber laser components.

FIG. 1 illustrates a very basic configuration of a narrow linewidth MOPFA system 10. The system 10 includes a seed 12—laser source outputting a narrow linewidth signal light at the desired signal wavelength. A modulator 14 is used to provide a high bandwidth signal for accurate ranging. A power fiber amplifier 16, hereafter referred to as booster, provides a high optical gain to the input modulated signal. The dedicated pump 18 outputs pump light which is coupled into booster 16 at a pump wavelength different from that of the signal light. The system 10 typically has a central processing unit (CPU) 20 controlling output of pump 18 and input to seed 12. As known, by comparison with other solid state amplifiers, the fiber amplifiers exhibit superior high thermal dissipation capabilities, good beam quality and compactness. However, the narrow spectral linewidth facilitates gain accumulation of SBS nonlinear phenomenon over the fiber length limiting useful applications of narrow linewidth fiber laser sources. While broadening the linewidth leads to a higher threshold of SBS, overly broad linewidths may render the source ineffective for the intended purposes.

The SBS can be understood as scattering of a photon to a lower energy photon such that the energy difference appears in the form of an acoustic phonon. The intensity of the scattered light grows exponentially. Upon reaching the SBS threshold, the power transfer from light at a signal wavelength to that at the undesirable SBS wavelength becomes a problem to reckon with. The SBS has well defined characteristics, such as (a) it occurs mostly in the backward direction, (b) the scattered light is shifted in frequency by about 10 GHz, and (c) the Brillouin gain spectrum has extremely narrow bandwidth typically lower than 100 MHz.

The SBS results in a loss of power of signal light at the incident frequency/desired wavelength for the following reason. When the scattered wave is generated spontaneously, it beats with the pump light and creates a frequency component at the beat frequency ωₚ-ωₛ, which is equal to the acoustic frequency Ω. As a result, the beating acts as the source that increases the amplitude of the sound wave, which in turn increases the amplitude of the scattered wave, resulting in a positive feedback loop. Thus the SBS has its origin in this positive feedback, which ultimately can transfer all power from the pump to the scattered wave.

Based on the foregoing, the high power backreflection and linewidth are critical to the onset of SBS. In practice, SBS is a result of random pulses originated anywhere within and beyond the high power laser source, but mainly in a power amplifier. The SBS pulses circulate within an artificially formed cavity which extends between any two reflective formations along the light path within and beyond the laser system. For example, the cavity can be formed between the laser-treated surface and the power amplifier's input end. In fact, impurities, splices, non-uniform dopant concentration in a gain medium and other inevitable obstacles within and beyond the laser system may form reflectors defining the cavity which typically includes at least a portion of the gain medium. As the SBS pulses travel back and forth through the gain medium, the SBS pulse peak power grows. If not prevented from completing the round trip in the cavity, the giant SBS pulse may reach a critical MW peak power in a 0.5-10 MW power range in CW MOPFA configuration which triggers a self-focusing nonlinear phenomenon in the fiber core. The latter is capable of completely destroying the gain media within a period of time ranging between about ×10 ns and about 500 ns. Furthermore, not only the booster is in danger of being irreparably damaged by this critical peak power, but also other in-line laser system components, such as the seed, pump diode lasers and pre-amplifiers, are vulnerable as well. Obviously, as powers of diffraction-limited laser outputs of the narrow linewidth laser sources grow, the SBS phenomenon becomes more and more problematic. Even more so when narrow linewidth MOPFA sources are spectrally combined using the Littrow configuration grating geometry to meet continuously growing requirements for higher powers.

Traditionally, once the SBS in narrow line MOPFA laser systems is detected to reach a certain SBS threshold safety range, power amplifier 16 of FIG. 1 is de-energized by shutting down amplifier's pump diodes 18. Only after the pump is turned off, seed 12 is typically de-energized. This method may be effective at relatively low powers. However, in high power narrow linewidth MOP(F)A systems, it takes more than one (1) microsecond (μs) to shut down pump 18 which usually has numerous high power multimode (MM) pump diode lasers. High injection currents of pump diodes require longer shut off time periods due to the wires' inductance. This time is sufficient for the formation of a SBS giant pulse which irreparably damages the booster as well as other laser components of the high power narrow linewidth MOPFA laser system.

A need therefore exists for a high power narrow linewidth MOPFA laser system provided with a safety mechanism which de-energizes the booster within a time period not exceeding 500 ns.

Another need exists for a method of de-energizing the booster in the high power narrow linewidth MOPFA laser systems within the above-mentioned time period.

### SUMMARY OF THE DISCLOSURE

These needs are met by the disclosed high power narrow linewidth MOPFA laser system based on a simple concept: in case of emergency, instead of initially turning off numerous MM pump diodes energizing the booster, it is a narrow-line seed which is either completely turned off or its output power is controllably decreased. Only after the output of the seed is at least lowered, the pump's output is dealt with. As a result, the output power of the booster is decreased to exclude SBS feeding conditions. As practice shows, in high power narrow linewidth MOPFA laser systems, the time period necessary for the detected back-reflected SBS to detrimentally affect the booster does not exceed a few hundreds of ns. The latter substantially equals the time sufficient to fully de-energize the seed which is typically a single frequency low power diode laser. In contrast, turning off multiple high power MM pump diode lasers takes longer than 1 μs which at kW laser system output powers may lead to a catastrophic failure of the booster and entire laser system.

One of the features of the disclosed method and system allows completely de-energizing the seed which can be selected from a narrow linewidth SM semiconductor and SM fiber lasers. Since the diode laser's output power depends on the injection current from a current source, further referred to as a driver, it is the latter that is turned off. Yet when the complete shut-down is not necessary, the drive current for a specific laser power can be controllably reduced by a signal from a CPU in response to the output of a photodetector monitoring the peak power of SBS light which propagates towards the seed. The amplitude of the photodetector's output provides a clear indication to the CPU as to whether the seed is to be completely or partially de-energized. In case of the narrow linewidth fiber seed, its output is energized by a dedicated pump which includes one or very few low power SM SF diode lasers that can be controlled similarly to the technique applicable to the semiconductor seed.

Alternatively, the control of the narrow linewidth seed's output can be realized by utilizing a variety of shutters such as fast-switching acousto-optical and electro-optical modulators (AOM and EOM respectively.) As well known to one of ordinary skill in the laser arts, both AOM and EOM devices control the transmitted power of a laser beam with an electrical drive signal. The shutter may be placed anywhere between the seed and booster or even mounted before the seed's input. In fact, any shutter that meets the required switching frequency may be part of the inventive MOPA system. Regardless of the location of the shutter, the power of the seed-generated signal light may be reduced to zero or to any desired low power value.

Essential to the disclosed concept is a control circuit for detecting and evaluating the amplitude of the SBS pulses and further for modulating the output of the seed. This feature is accomplished by detecting back-reflected (BR) SBS light anywhere between the booster and seed. The photodetector outputs a signal corresponding to the detected SBS pulse power which is received in a CPU where it is compared to a reference value stored in the CPU's memory. If the detected signal is below a predetermined reference SBS threshold safety range, the MOP(F)A source continues to operate. Otherwise, depending on how far apart the detected signal and reference value are, the CPU outputs a control signal either completely shutting down the seed generated signal light or partially reducing its power. The above-disclosed features including initially controlling the seed output and subsequently the pump output, if necessary, completely de-energize the power amplifier within a few μs sufficient for the full inversion depopulation.

Still other features are discussed in detail below. Moreover, it is to be understood that both the foregoing information and the following detailed description are merely illustrative examples of various aspects and embodiments, and are intended to provide an overview or framework for understanding the nature and character of the claimed method and apparatus.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a general schematic of the known high power narrow linewidth laser system having a MOPA configuration;

FIG. 2 is an optical schematic of the disclosed high power narrow linewidth MOPFA laser source configured to output a diffraction-limited beam.

### SPECIFIC DESCRIPTION

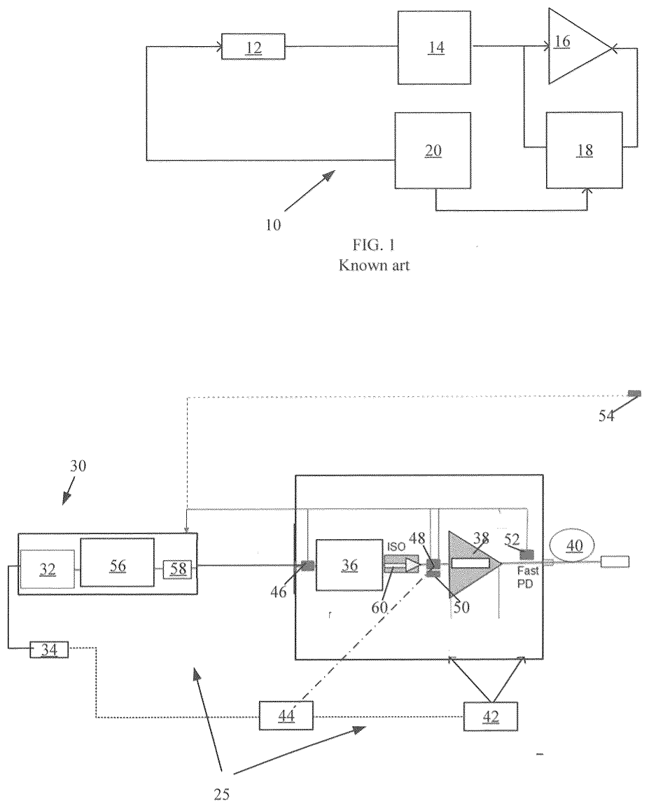

FIG. 1 illustrates the inventive concept carried out by an exemplary schematic of high power narrow linewidth fiber laser system 25. As shown, system 25 has the MOPFA architecture including a seed module 30 which houses, among others, a narrow linewidth SM seed source (seed) 32. The seed 32 can be, for example, a suitable narrow linewidth semiconductor or fiber laser well known to one of ordinary skill in the laser arts. Typically seeds 32 laces a SF or very narrow linewidth milliwatt-level (mW) signal at the desired wavelength in response to the injection current from a driver 34 which can be integrated in seed module 30 or configured as an external source.

Propagating through an amplifying module including one or more preamplifier stages 36, the pre-amplified signal is eventually coupled into a booster 38 also enclosed within the amplifier module. At the output of booster 38, the signal light is provided with a high gain and reaches the desired high powers in a 1-5 kW range, which may, in the future, be possibly expanded to a 10 kW upper limit. The amplified signal light is then guided via a delivery fiber 40 to the target to be irradiated.

As the amplified signal light propagates along the light path within and beyond system 25, it inevitably encounters a variety of reflective formations. One obvious formation is the target to be laser treated, but the latter is far from being the only one. Every fiber splice—and there are plenty of them along a fiber train between adjacent fibers, uneven doping concentration in gain media, faucets, literally each and every system component can potentially reflect forward propagating signal light. And that backreflection unfortunately opens the door to the laser purgatory-generation of nonlinear effects in high power laser systems in general and, in particular, in high power narrow linewidth MOPFA sources outputting diffraction limited light.

In MOPFA configurations, long interaction fiber lengths and small mode-field fiber cores “enhance” nonlinear effects which prohibit scaling to larger output power. For narrow-linewidth signal amplification, the SBS phenomenon becomes the dominant limitation. To some extent, the SBS threshold can be raised by increasing the fiber core size, decreasing fiber length and somewhat broadening the linewidth of the seed's output. The shown schematic incorporates many of the known mechanisms helping raise the SBS threshold. Unfortunately, it is impossible to fool the nature, and bad things, such as undesirable nonlinear effects, happen. What to do when these effects and particularly SBS reach critical high powers that do not just simply affect the performance but critically threaten to destroy system components? The answer to this question is perhaps universal to all sorts of high power sources: de-energize the power source or at least reduce its output power to prevent SBS (and other nonlinear effects) from reaching critical powers at which the booster as well as any of other components of system 25 can be damaged. Typically it is realized by initially controlling a pump 42 energizing booster 38 and including multiple MM diode lasers. In contrast, the inventive concept is based on initially controlling the output of low power seed source or seed 32 and then dealing with pump 42.

According to the inventive method, a safety threshold range of backreflected (BR) SBS pulse peak power, which, if the pulse is allowed to complete a round trip within the cavity, leads to its MW critical power level, is detected. Thereafter, either seed 32 is completely shut down or at least its output power is decreased by controllably de-energizing driver 34. In the disclosed here MOPFA systems, a full shutdown of seed 32, which happens only after the detected SBS pulse has a peak power within a predetermined ×10 W-kW safety threshold range, lasts anywhere between about 50 ns and about 500 ns. This time period is sufficient to prevent the detected SBS pulse from developing into a giant 1-5 MW SBS pulse which can be deadly to all fiber components of high power narrow linewidth MOPFA source 25. Only after the seed's output is dealt with, pump 42 energizing booster 38 is shut down which typically takes more than 1 μs.

The inventive method is carried out by providing laser system 25 with a control circuit including, among others, a central processing unit (CPU) 44 and one or more photodetectors (PD) 48 detecting BR SBS light and located between the output of seed 32 and input of booster 38. The output of fast PD 48 is coupled to CPU 44 determining whether the detected back-reflected light has reached a safety threshold energy range of SBS light varying between 1 uJ and 100 uJ. The detection of the SBS light within this range is a reliable indication that once the measured light bounces back from a downstream reflective formation and propagates through at least a portion of booster 38 in a forward propagating direction, it will be amplified to the critical SBS peak power varying within a 0.5-10 MW range. As one of ordinary skill readily realizes, the critical SBS peak range may somewhat differ from the one disclosed above, but the latter was detected time and again in experimental CW laser systems with an output power varying between 1-5 KW. To prevent the measured SBS peak power from reaching the critical peak power, CPU 44 outputs a control signal either completely shutting down driver 34 of seed 32, or at least controllably reducing its input until the measured peak power of the BR SBS light is below the safety threshold range. Regardless of the controlling regime of driver 34, the measured SBS peak power should be reduced within a 50-500 ns time period. As to the lower limit of the safety peak power range, it can be just a few hundred watts, for example 500 W.

Besides PD 48, system 25 may include PD 46 detecting an input power of forward propagating light signal at the desired signal wavelength into any of preliminary amplifying stages 36. The PD 50 detects pre-amplified light at the input of booster 38, whereas PD 52 measures the output power of the signal light in the forward propagating directions. The control system can be configured with an external fast PD 54 which is under control of the system's operator and operable to detect a malfunction of seed module 30. As one of ordinary skill readily realizes, the number and location of PDs can be varied in accordance with the system's design. For example, the control system can be configured to exclusively measure the BR SBS pulse peak power utilizing PD 48 only. Any of the shown or other optional PDs can control the system malfunction attributed to other optical effects, such as transversal mode instability, fiber fuse and others which may damage the booster or any other component of system 25.

Turning specifically to the components of high power narrow linewidth fiber system 25, seed 32 may have various configurations. Generally, to obtain a SF/narrow linewidth output seed 32 may be selected from external cavity lasers (ECL), distributed feedback (DFB), volume holographic grating (VHG), and distributed Bragg reflector (DBR). All four are capable of SF output through the utilization of grating feedback. In addition, the ECL can be combined with a fiber Bragg grating (FBG) to create a hybrid design. Each configuration uses a different grating feedback configuration, which influences performance characteristics such as output power and others. Alternatively, of course, SF and narrow linewidth fiber lasers can be incorporated in system 25 without compromising the inventive concept of the present disclosure.

The booster 38 used in system 25 is configured with SM input and output passive fibers flanking a MM active fiber. To minimize the excitation of high order modes and thus mainly amplify a fundamental mode, the active fiber is appropriately doped and shaped to provide the fundamental mode with a mode field diameter (MFD) which matches respective MFDs of SMs supported by respective input and output booster fibers. Typically, the MM active fiber has a double bottleneck cross-section with a large diameter middle core region bridging smaller core diameter end regions. The examples of such active fibers are disclosed in U.S. Pat. Nos. 7,848,368, 8,655,121 respectively which are fully incorporated herein by reference.

The booster 38 is energized by pump 42 which includes multiple high power MM diode lasers. The pump scheme can include a bi-directional coupling of pump light into booster 38. Alternatively, a unidirectional delivery of pump light to booster 38 is also contemplated within the scope of this invention. The number of MM diode lasers can be 18 diode lasers and even more on each of the opposite pump branches delivering pump light to respective opposite booster ends.

Besides the above-disclosed system components, laser module 30 may include an AOM or EOM modulator 56 configured to control a linewidth and a power of the seed-laced signal before it is launched into subsequent amplifying stages. The use of the modulator or, in fact, any appropriately configured light shutter between seed 32 and booster 38 is considered an addition to or alternative to controlling driver 34 of seed 32. The seed module 30 may also be provided with a depolarizer 58 as customary for high power MOPFA laser systems provided with a seed outputting depolarized light signal. Following the light path of the seed's signal light along system 25, an isolator 60 minimizes backreflection propagation of light at the desired wavelength.

The exemplary narrow linewidth laser MOPFA system 25 has been tested in accordance with the following selective parameters. Operating in a CW regime, seed 32 outputs linearly polarized narrow linewidth signal light at the desired 1055-1070 nm wavelength range and has an output power ranging in a 5-10 mW power range. At the output of booster 38, the amplified signal light is detected to have an output power within a 1-5 kW power range with the same linewidth and output beam quality factor M² varying from 1.06 to 1.1.

The features disclosed herein in accordance with the present invention, are not limited in their application to the details of construction and the arrangement of components set forth in the following description or illustrated in the accompanying drawings. For example, while SBS in solid state amplifiers of high power MOPA laser systems may not be important, it does not mean that in critical situations, the fast and effective shutdown of a solid state power amplifier is disadvantageous. In this scenario, the inventive concept is fully applicable to a variety of MOPA systems. These features are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the following claims. Accordingly, the foregoing description and drawings are by way of example only.

What is claimed is:

1. A method for operating a high power narrow linewidth laser system having a master oscillator power fiber amplifier (MOPFA) architecture with a master oscillator (MO) and booster, comprising
detecting stimulated Brillouin scattered (SBS) light propagating backwards from the booster to the MO, therefore determining whether a SBS pulse peak power or SBS pulse energy of the detected SBS light is within a threshold safety power range; and
if the detected SBS light is within the threshold power safety range, controllably decreasing an output power of the MO-generated forward propagating signal light within a preset time period which is sufficient to prevent the detected SBS peak power from reaching a critical peak power.

2. The method of claim 1, wherein the step of controllably decreasing the output power of the signal light includes fully or partially de-energizing the MO within the preset time period.

3. The method of claim 2, wherein the step of controllably decreasing the output power of the MO-generated signal light includes decreasing an injection current from a current source of the MO, the MO being a narrow linewidth diode laser.

4. The method of claim 1, wherein the step of controllably decreasing the output power of the MO-generated signal light includes generating an electrical signal by an acousto-or electro-optical modulator.

5. The method of claim 1, wherein the step of controllably decreasing the output power of the MO-generated signal light includes turning off a pump of the MO, the MO being a narrow linewidth fiber laser.

6. The method of claim 2 further comprising controllably turning off a pump energizing the booster.

7. The method of claim 1, wherein the threshold power safety range of the SBS light varies between about 0.5 kW and 1.5 kW.

8. The method of claim 1, wherein the preset time period varies between about 50 ns and 500 ns.

9. The method of claim 1, wherein the critical peak power of the SBS light varies in a 0.5-10 MW power range.

10. A high power narrow linewidth laser system with a master oscillator power fiber amplifier (MOPFA) architecture which includes a master oscillator (MO) and booster, comprising:
at least one photodetector (PD) operative to detect pulsed stimulated Brillouin scattered (SBS) light propagating backwards from the booster to the MO and converting the detected SBS light to an electrical signal which corresponds to a pulse peak power of the detected SBS light;
a central processing unit (CPU) receiving the electrical signal and operable to determine if the peak power of the SBS light is within a threshold safety energy range of the SBS light, wherein if the peak power is within the threshold safety range, the CPU is operative to controllably decrease an output power of MO-generated signal light within a preset time period sufficient to prevent the determined peak power of the detected SBS light from reaching a critical peak power thereof.

11. The laser system of claim 10, wherein the MO is a narrow linewidth diode laser selected from an external cavity laser (ECL), distributed feedback (DFB), distributed Bragg reflector (DBR) or volume holographic grating.

12. The laser system of claim 11 further comprising a current source coupled to the laser diode, the source being in electrical communication with and receiving a control signal from the CPU which is operable to generate an electrical signal if the determined peak power of the detected SBS light is determined to be within the threshold safety energy range,
wherein the current source is either completely turned off or controllably decreasing the output current within the preset period of time so as to reduce a power of the MO-generated signal light such that that the pulse peak power of the detected SBS light is below the critical peak power thereof.

13. The laser system of claim 10, wherein the MO is a narrow linewidth fiber laser energized by a dedicated pump diode laser, the pump diode laser is either completely de-energized or controlled to reduce a power of the MO-generated signal light within the preset period of time so that the pulse peak power of the detected SBS light is below the critical peak power thereof.

14. The laser system of claim 10 further comprising a shutter located downstream from the PA and controllably reducing the output power of the MO-generated signal light within the preset period of time so as to lower the peak power of the detected SBS light below the critical peak power.

15. The laser system of claim 14, wherein the shutter is an acousto-optical modulator or electro-optical modulator.

16. The laser system of claim 10, wherein the booster is energized by a pump including a plurality of multimode diode lasers which are arranged to output pump light coupled into one of input and output ends of the booster or in both input and output ends thereof, the CPU being in electrical communication with the pump so as to turn it off after the MO is turned off.

17. The laser system of claim 10 further comprising one or more pre-amplifying stages between the MO and the booster, and in-line linewidth broadening component and depolarizer located between the MO and pre-amplifying stages.

18. The laser system of claim 16, wherein the booster is configured with
a multimode (MM) active fiber doped with one or more rare-earth ions and having a double bottle-neck-shaped cross-section, and
a pair of single mode passive fibers spliced with respective opposite ends of the active fiber, wherein the MM active fiber supports substantially only a fundamental mode having a mode field diameter (MFD) which matches that one of the SM passive fibers.

19. The laser system of claim 10, wherein the power of the MO-generated amplified signal light at an output of the booster varies in a 1-5 kW power range.

20. The laser system of claim 10 further comprising a plurality of additional photodetectors located along a light path of the MO-generated signal light and operative to detect a power thereof in forward-and backward propagating directions.

21. The laser system of claim 10, wherein the threshold safety energy range of the SBS light ranges between about 1 and 100 μJ.

22. The laser system of claim 10, wherein the preset time period varies between about 50 ns and 500 ns.

23. The laser system of claim 10, wherein the critical peak power of the SBS light varies in a 0.5-10 MW power range.

24. The laser system of claim 10, wherein the narrow line width is less than 1 nm.
